(19) United States
(12) Patent Application Publication
(10) Pub. No.: US 2002/0013765 A1
(43) Pub. Date: Jan. 31, 2002

(54) Intrinsic authorization for electronic transactions

(76) Inventor: Gil Shwartz, Ramat Gan (IL)

Correspondence Address: ABELMAN FRAYNE & SCHWAB, Attorneys at Law, 150 East 42nd Street, New York, NY, 10017, US

(21) Appl. No.: 09/863,119

(22) Filed: May 22, 2001

Related U.S. Application Data
(60) Provisional application No. 60/206,567, filed on May 23, 2000.

(51) Int. Cl. G06F 17/60

(52) U.S. Cl. 705/39

(57) ABSTRACT

A computer implemented system of automated intrinsic authorization of on-line electronic transactions is disclosed. The system involves the use of a merchant transaction tracking service that identifies the transaction, using a unique transaction identifier, and manages the authorization process. The merchant transaction tracking service also provides authentication of aspects of the transaction and its participants during the authorization process. The merchant need not contact the customer's credit card company directly, as a communication that includes the transaction identifier is embedded in the merchant's payment form. The payment form is transmitted to the customer, and then relayed to the credit card issuer. Authentication is provided automatically, using an encrypted certificate bearing the digital signature of the credit card issuer. The digital certificate is associated with the transaction identifier, and is transferred to the merchant transaction tracking service, which then verifies the transaction to the merchant.

### CROSS-REFERENCE TO RELATED APPLICATIONS

This application claims the benefit of Provisional Application No. 60/206,567, filed May 23, 2000.

### BACKGROUND OF THE INVENTION

1. Field of the Invention

This invention relates to the execution of electronic transactions. More particularly this invention relates to a technique of obtaining authorization for an electronic transaction, such as a credit card transaction, from a responsible authority, without need for direct contact between a vendor and the authority.

2. Description of the Related Art

Numerous online payment methods have been proposed to handle the problems of managing ecure and non-repudiated Internet payment transactions. Most attempt to replace the credit card as a payment mechanism with some alternative mechanism. This usually requires a network of merchants, which would support such methods and accept an alternate form of payment. Consumers desiring to participate must trouble to establish a relationship with the operator of such a network.

In copending Application Ser. No. 09/737,148, filed Dec. 14, 2000, of common assignee herewith, and herein incorporated by reference, a computer implemented technique for facilitating secure electronic transactions anonymously is disclosed. In this technique a secure private agent establishes a client relationship with a customer, and mediates communication between the customer and electronic commerce sites over a data network, such as the Internet. The secure private agent substitutes internally generated identifiers for personal details of the customer, completes details of the transaction on behalf of the customer, and in some embodiments provides payment authorization. The secure private agent concurrently monitors Internet browsing activity of the customer and provides its services on demand, or automatically in background mode.

The present invention provides enhancements and improvements that are operative with the teachings of the above noted application Ser. No. 09/737,148, and are also operative in transaction systems not employing a secure private agent.

### SUMMARY OF THE INVENTION

It is therefore a primary object of some aspects of the present invention to embed a reliable authorization of an authority bearing responsibility for authorizing the transaction in conventional communications between parties to the transaction.

It is another object of some aspects of the present invention to provide authorization for an electronic transaction automatically, without an explicit request for such authorization by a party to the transaction to the authority bearing responsibility for authorizing the transaction.

It is yet another object of some aspects of the present invention to verify the authenticity of a credit card transaction automatically without need for a merchant to contact the credit card issuer of the customer.

It is a further object of some aspects of the present invention to reduce the costs of authorizing and clearing electronic credit card transactions.

The process of automatic authorization of an electronic transaction according to the present invention, herein referred to as “intrinsic authorization” (IA), is an enhancement to conventional arrangements for completing electronic transactions, which are usually operated by companies such as credit card issuers. Such conventional arrangements are responsible for providing the financial information required in order to transfer financial credits and fund the transaction, and to monitor the process for purposes of fraud detection and prevention.

Intrinsic authorization covers two basic aspects of the transaction. The first aspect relates to the authenticity of the transaction itself, including confirmation that a real guarantor, such as a credit card issuer, is involved, identification of the customer, identification of the merchant, and documentation of the transaction. The second aspect is a credit check and approval of the customer's credit account, which is essentially the equivalent of a conventional credit card authorization. By simplifying and automating the process of transaction authorization, risk to the various parties is minimized, and transaction costs are reduced. The resultant increase in economic efficiency is expected to translate into lowered costs for both the merchant and customer, possibly in the form of discounts as an inducement to use intrinsic authorization.

The invention provides a computer implemented method of authorizing an electronic transaction, which includes receiving a notification of a pending electronic transaction from a first participant therein, wherein another participant is an authority responsible for authorizing the pending electronic transaction. The method includes, responsive to the notification, associating a transaction identifier with the pending electronic transaction, communicating the transaction identifier to the first participant, wherein the first participant relays the transaction identifier to at least one other participant in the pending electronic transaction, thereafter receiving the transaction identifier and a digital certificate that authorizes the pending electronic transaction, wherein the digital certificate is signed by the authority. The method includes verifying the digital certificate, and providing an indication of the digital certificate.

An aspect of the method includes authenticating the first participant to a second participant in the electronic transaction upon a request therefrom that is associated with the transaction identifier.

According to an additional aspect of the method, the second participant is the authority.

According to another aspect of the method, the indication of the digital certificate is provided to the first participant.

According to another aspect of the method, the indication of the digital certificate is provided in response to a transaction verification request of the first participant.

According to a further aspect of the method, the indication of the digital certificate is provided automatically.

According to yet another aspect of the method associating the transaction identifier is associated by generation thereof.

According to still another aspect of the method, the transaction identifier is associated by providing the first participant with a range of transaction identifiers, wherein the first participant allocates the transaction identifier from the range, and receiving the transaction identifier from the first participant.

According to an additional aspect of the method the transaction identifier is associated by providing the first participant with a rule for generating transaction identifiers, wherein the first participant generates the transaction identifier in accordance with the rule, and receiving the transaction identifier from the first participant.

According to one aspect of the method receiving the notification, communicating the transaction identifier, receiving the transaction identifier and the digital certificate, and providing the indication are all accomplished using a data network.

According to another aspect of the method, the data network is an internet.

According to yet another aspect of the method, the digital certificate is encrypted by a private key of the authority.

The invention provides a computer implemented method of authorizing an on-line credit card transaction between a customer and a merchant, including the steps of receiving a notification of the on-line credit card transaction from the merchant via a data network, associating a transaction identifier with the on-line credit card transaction, communicating the transaction identifier to the merchant via the data network, wherein responsive to receiving the transaction identifier, the merchant includes the transaction identifier in a payment form that is submitted to the customer, and the customer relays the transaction identifier to an authority responsible for authorizing the on-line credit card transaction and returns the payment form to the merchant. According to the method, an identifier of a credit card account of the customer is communicated with the payment form. The method includes receiving via the data network the transaction identifier and a digital certificate that includes the identifier of the credit card account and authorizes the on-line credit card transaction, the digital certificate being signed by the authority. The method includes verifying the digital certificate, and providing an indication of the digital certificate to the merchant via the data network.

An aspect of the method includes, following communication of the transaction identifier to the merchant, receiving via the data network the transaction identifier and a request from the customer to authenticate the merchant, the request including the transaction identifier, and responsive to the request, verifying an identity of the merchant to the customer via the data network.

Another aspect of the method includes, following communication of the transaction identifier to the merchant, receiving via the data network the transaction identifier and a request from the authority to authenticate the on-line credit card transaction, the request including the transaction identifier, and responsive to the request, communicating an authentication of the on-line credit card transaction to the authority via the data network.

According to a further aspect of the method, the digital certificate is received from the authority.

According to yet another aspect of the method, the digital certificate is received from the customer.

According to still another aspect of the method, the digital certificate is received from the merchant.

According to an additional aspect of the method, the indication of the digital certificate is provided responsive to a transaction verification request from the merchant.

According to one aspect of the method, the indication of the digital certificate is provided automatically.

According to another aspect of the method, the transaction identifier is associated by generating the transaction identifier.

According to a further aspect of the method associating the transaction identifier is performed by providing the merchant with a range of transaction identifiers, wherein the merchant allocates the transaction identifier from the range, and receiving the transaction identifier from the merchant.

According to yet another aspect of the method the transaction identifier is associated by providing the merchant with a rule for generating transaction identifiers, wherein the merchant generates the transaction identifier in accordance with the rule, and receiving the transaction identifier from the merchant.

According to still another aspect of the method, the transaction identifier is embedded in a hidden field of the payment form.

According to an additional aspect of the method, the transaction identifier is embedded in a visible field of the payment form.

According to still another aspect of the method, the digital certificate is encrypted by a private key of the authority.

The invention provides a computer implemented method of authorizing an on-line credit card transaction between a customer and a merchant, including the steps of receiving a notification of the on-line credit card transaction from the customer via a data network, associating a transaction identifier with the on-line credit card transaction, communicating the transaction identifier to the customer via the data network, wherein responsive to receiving the transaction identifier, the customer includes the transaction identifier in a communication that is submitted to an authority responsible for authorizing the on-line credit card transaction, and returns a payment form to the merchant, wherein an identifier of a credit card account of the customer is communicated with the payment form. The method includes receiving, via the data network, the transaction identifier and a digital certificate that includes the identifier of the credit card account, and authorizes the on-line credit card transaction, the digital certificate being signed by the authority. The method includes verifying the digital certificate, and providing an indication of the digital certificate to the merchant via the data network.

An aspect of the method includes, following communication of the transaction identifier to the customer, receiving via the data network the transaction identifier and a request from the authority to authenticate the on-line credit card transaction, the request including the transaction identifier, and responsive to the request, providing an authentication of the on-line credit card transaction to the authority via the data network.

According to a further aspect of the method, the digital certificate is received from the authority.

According to yet another aspect of the method, the digital certificate is received from the customer.

According to still another aspect of the method, the digital certificate is received from the merchant.

According to an additional aspect of the method, the indication of the digital certificate is provided responsive to a transaction verification request from the merchant.

According to one aspect of the method, the indication of the digital certificate is provided automatically.

According to another aspect of the method associating the transaction identifier includes generating the transaction identifier.

According to a further aspect of the method associating the transaction identifier is accomplished by providing the customer with a range of transaction identifiers, wherein the customer allocates the transaction identifier from the range, and receiving the transaction identifier from the customer.

According to yet another aspect of the method associating the transaction identifier is accomplished by providing the customer with a rule for generating transaction identifiers, wherein the customer generates the transaction identifier in accordance with the rule, and receiving the transaction identifier from the customer.

According to an additional aspect of the method, the digital certificate is encrypted by a private key of the authority.

The invention provides a computer implemented method of authorizing an on-line credit card transaction between a customer and a merchant, including the steps of receiving a notification of the on-line credit card transaction from an authority responsible for authorizing the on-line credit card transaction via a data network, associating a transaction identifier with the on-line credit card transaction, communicating the transaction identifier to the authority via the data network, receiving via the data network the transaction identifier and a digital certificate that authorizes the on-line credit card transaction, the digital certificate being signed by the authority, verifying the digital certificate. The method includes providing an indication of the digital certificate to the merchant via the data network.

An aspect of the method includes authenticating the on-line credit card transaction, and providing an authentication of the on-line credit card transaction to the customer or the authority via the data network.

According to one aspect of the method, the digital certificate is received from the authority.

According to another aspect of the method, the digital certificate is received from the customer.

According to a further aspect of the method, the digital certificate is received from the merchant.

According to yet another aspect of the method, the indication of the digital certificate is provided responsive to a transaction verification request from the merchant.

According to still another aspect of the method, the indication of the digital certificate is provided automatically.

According to an additional aspect of the method associating the transaction identifier is accomplished by generating the transaction identifier.

According to one aspect of the method associating the transaction identifier is accomplished by providing the authority with a range of transaction identifiers, wherein the authority allocates the transaction identifier from the range, and receiving the transaction identifier from the authority.

According to a further aspect of the method associating the transaction identifier is accomplished by providing the authority with a rule for generating transaction identifiers, wherein the authority generates the transaction identifier in accordance with the rule, and receiving the transaction identifier from the authority.

According to one aspect of the method, the digital certificate is encrypted by a private key of the authority.

### BRIEF DESCRIPTION OF THE DRAWINGS

For a better understanding of these and other objects of the present invention, reference is made to the detailed description of the invention, by way of example, which is to be read in conjunction with the following drawings, wherein:

FIG. 1 is a block diagram of an arrangement for conducting electronic commerce, which is operable in accordance with a preferred embodiment of the invention;

FIG. 2 is a block diagram illustrating certain aspects of a portion of the arrangement of FIG. 1 in further detail;

FIGS. 3A-3C, collectively referred to herein as FIG. 3, are a flow chart illustrating a process of intrinsic authorization of an electronic transaction in accordance with a preferred embodiment of the invention;

FIGS. 4A-4B, collectively referred to herein as FIG. 4, are a flow chart illustrating a process of intrinsic authorization of an electronic transaction in accordance with a first alternate embodiment of the invention; and

FIGS. 5A-5C, collectively referred to herein as FIG. 5, are a flow chart illustrating a process of intrinsic authorization of an electronic transaction in accordance with a second alternate embodiment of the invention.

### DESCRIPTION OF THE PREFERRED EMBODIMENT

In the following description, numerous specific details are set forth in order to provide a thorough understanding of the present invention. It will be apparent however, to one skilled in the art that the present invention may be practiced without these specific details. In other instances well known circuits, control logic, and the details of computer program instructions for conventional algorithms and processes have not been shown in detail in order not to unnecessarily obscure the present invention.

Software programming code, which embodies aspects of the present invention, is typically maintained in permanent storage, such as a computer readable medium. In a client/server environment, such software programming code may be stored on a client or a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and distributing software code via networks are well known and will not be further discussed herein.

Although for convenience of presentation the invention is disclosed in terms of a customer and a merchant in the context of a credit card transaction, the invention is not limited in scope to such parties and contexts, but is broadly applicable to many forms of electronic commerce in which authorization for a transaction is required from a party other than two parties desiring to engage in a transaction. For example, the invention is applicable to transactions in the health care industry, which is financed using third or fourth parties who insist on pre-approval of proposed transactions or medical procedures.

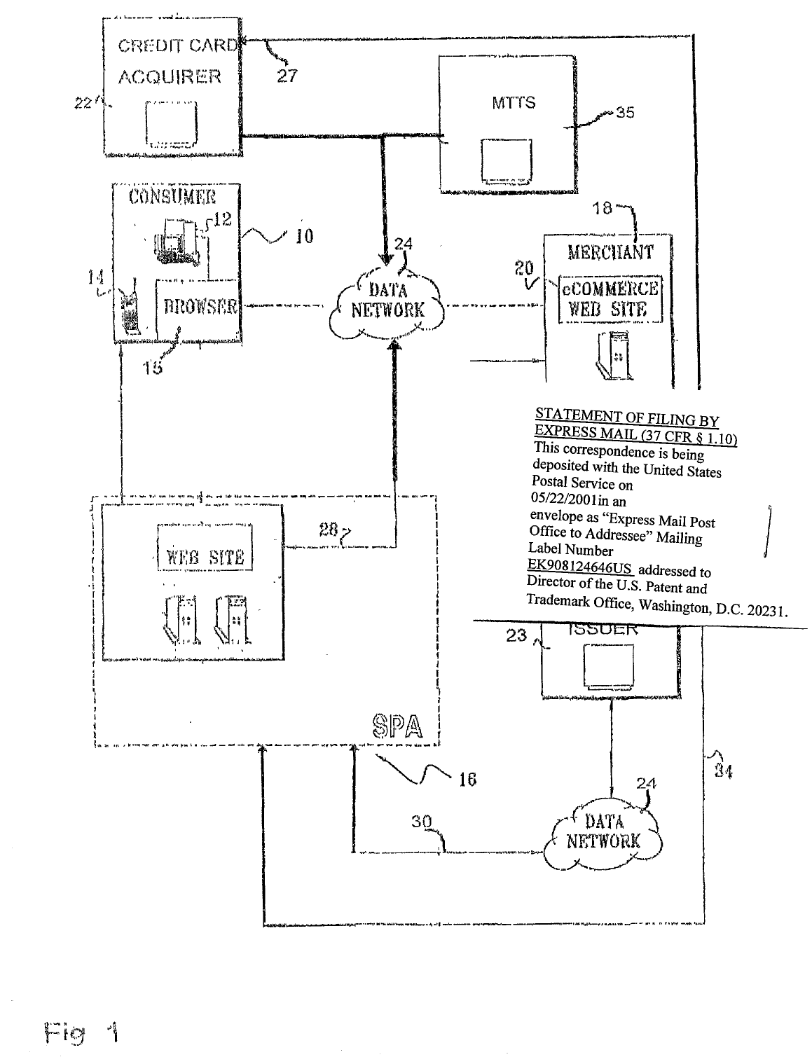

Turning now to the drawings, and in particular to FIG. 1, a high level view of an arrangement for conducting electronic commerce is shown, which is operated in accordance with a preferred embodiment of the invention. A customer 10 desiring to engage in electronic commerce is provided with a communication device 12, and optionally with a telephone device 14. The communication device 12 is preferably a personal computer equipped with a modem, but could be any suitably programmed wireless device, a personal digital assistant, or the like. The telephone device 14 can be a cellular telephone, a conventional telephone, or a networking device such as a net card associated with the personal computer, or a wireless device. Other parties to electronic commerce include a secure private agent 16, a merchant 18 having an electronic commerce site 20, and a credit card transaction processor, or acquirer 22, with whom the merchant 18 has a relationship. The secure private agent 16 is preferably the agent that is disclosed in further detail in the above noted application Ser. No. 09/737,148. An important purpose of the secure private agent 16 is to enable the customer 10 to conduct electronic transactions securely, financially anonymously, and without revealing other private information to the merchant. A credit card issuer 23 provides credit to the customer 10, and authorizes the transaction. Conventionally the issuer 23 is linked to the acquirer 22 via a private payment network 25, for example the network operated by the proprietors of VISA®, using the channel 27.

The customer 10 normally communicates, using a browser 15, with elements of the secure private agent 16 via a data network 24, which can be the Internet, on a secure or insecure Internet channel. Encryption of the network communications by known methods may be employed. The customer 10 and the merchant 18 communicate via the data network 24. In some preferred embodiments of the invention the data network channels are wireless channels. During an electronic commerce transaction, a communication channel 28 may be established via the Internet between the secure private agent 16 and the merchant 18. An additional communication channel 30 may be established between the secure private agent 16 and the issuer 23, preferably via a private network. In some embodiments, the secure private agent 16 can communicate directly with the issuer 23 using the private payment network 25 over the channel 34. A merchant transaction tracking service 35 (MTTS) is also connected to the data network 24, the function of which will be disclosed in further detail below.

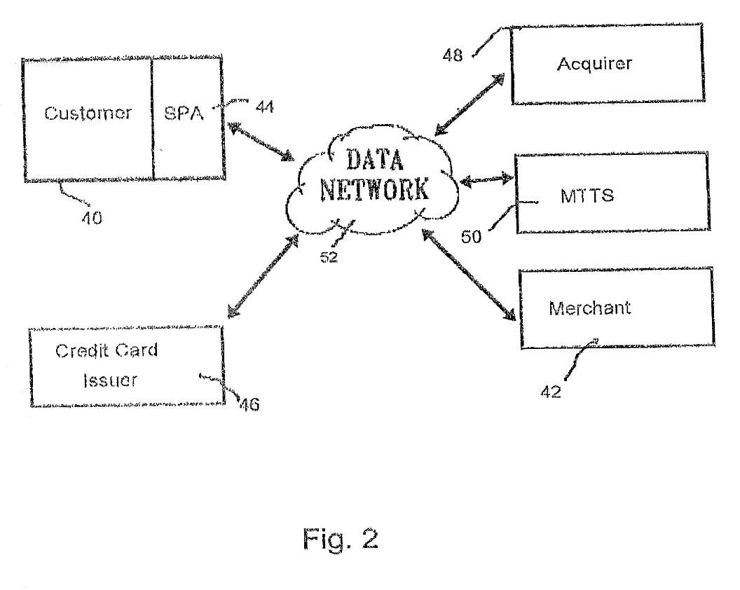

Reference is now made to FIG. 2, which is a block diagram illustrating certain aspects of an arrangement similar to the arrangement of FIG. 1. A customer 40 and a merchant 42 are the proponents of a proposed electronic transaction. The customer 40 preferably has an existing relationship with a secure private agent 44. The disclosure herein references the customer 40 as party to various activities and communications between itself and other interested parties to the transaction. However, it will be understood that the secure private agent 44 preferably mediates these activities and communications in the manner disclosed in the above noted application Ser. No. 09/737,148. The details of such mediation are omitted in the interest of brevity. In some embodiments, the secure private agent 44 may be omitted entirely.

The customer 40 has an account with a credit card issuer 46, which is an authority responsible for authorizing electronic transactions of the customer 40. The merchant 42 deals with an acquirer 48 in settling credit card transactions with customers. A merchant transaction tracking service 50 (MTTS) is an additional participant, and plays a key role in the invention. The purpose of the merchant transaction tracking service 50 is to administer the process of obtaining authorization for the transaction from the issuer 46. The merchant transaction tracking service 50 communicates with other parties to the transaction, collecting information necessary to induce the issuer 46 to issue an authorization, and verifying the authenticity of the parties and the information that they provide. In some embodiments the merchant transaction tracking service 50 may be operated by the merchant 42, while in other embodiments it may be controlled by the acquirer 48, or may even be operated as an independent enterprise. Usually the merchant 42 has a preexisting relationship with the merchant transaction tracking service 50. The customer 40, the merchant 42, the secure private agent 44, the issuer 46, the acquirer 48 and the merchant transaction tracking service 50 are able to intercommunicate over the data network 52.

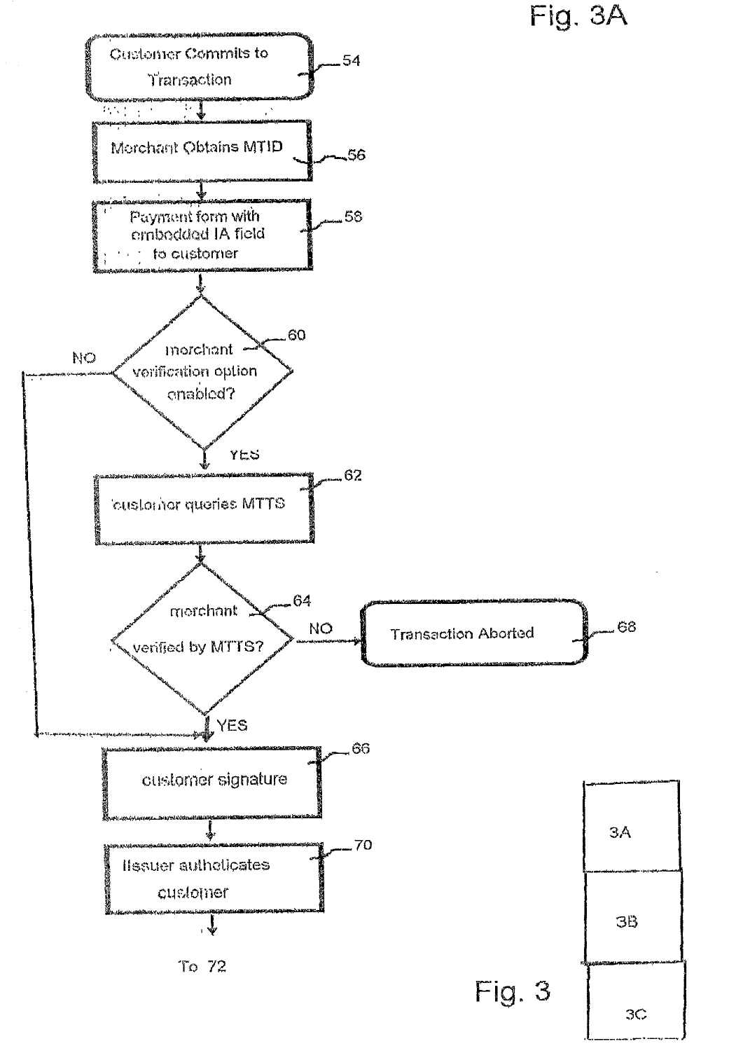

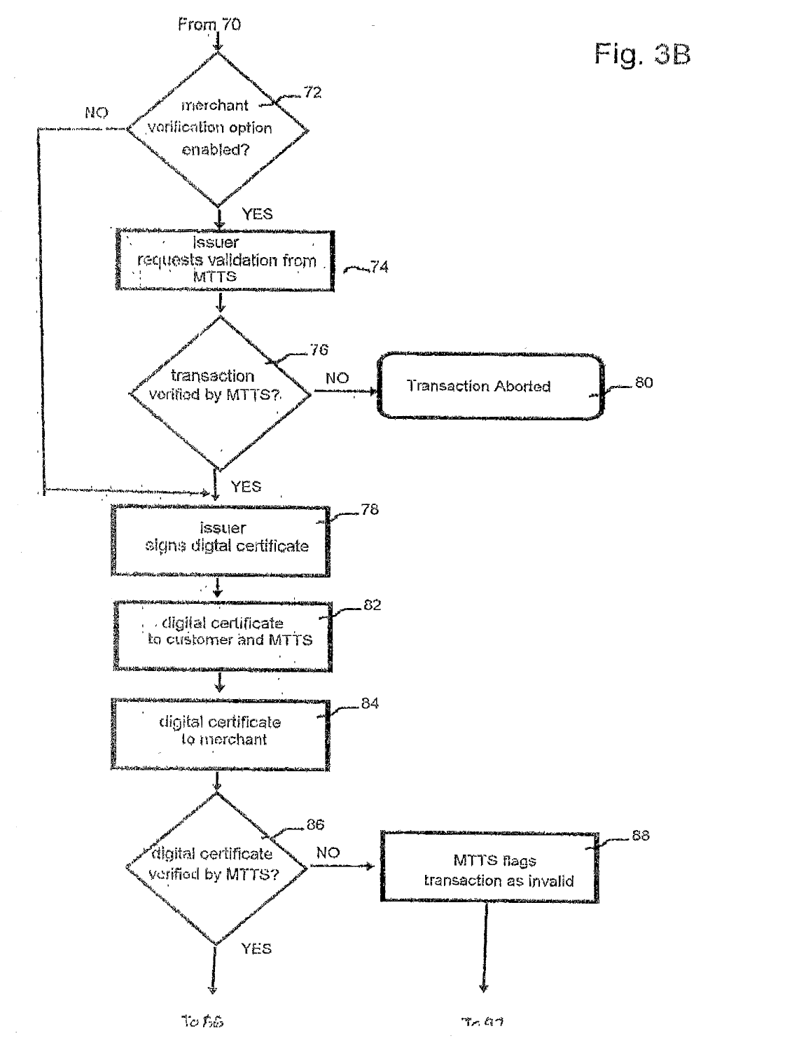

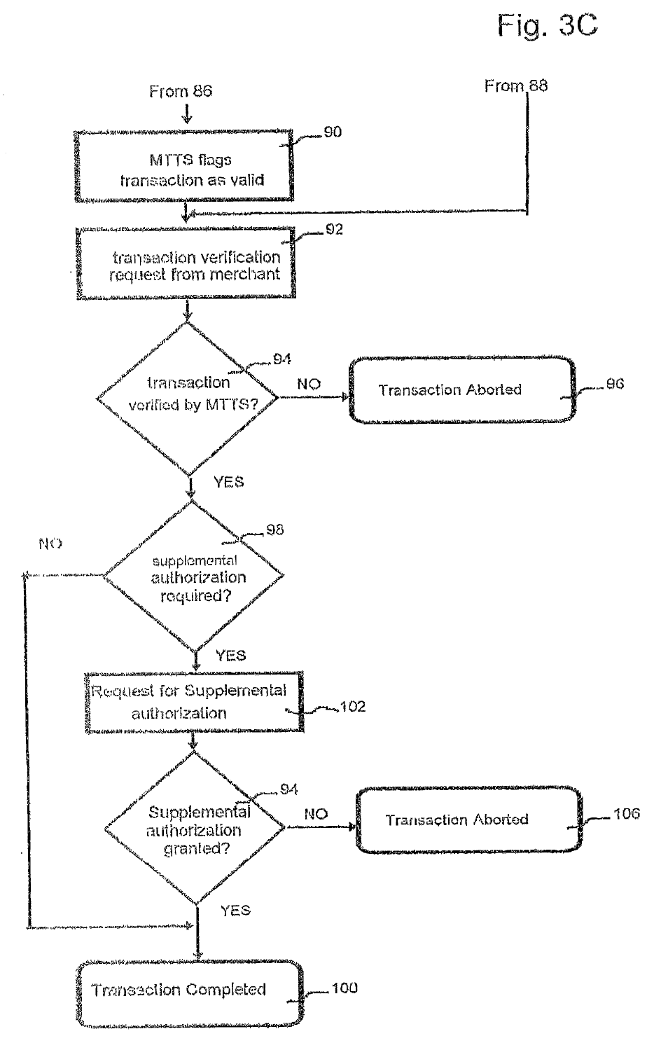

Reference is now made to FIG. 3, which is a flow chart illustrating a process of intrinsic authorization of an electronic transaction in accordance with a preferred embodiment of the invention. The description of FIG. 3 is to be read in conjunction with FIG. 2. At initial step 54 the customer 40 accesses the electronic commerce site of the merchant 42 and provides an indication of intent to commit to an electronic transaction. Initial step 54 is accomplished by the customer 40 in a conventional manner, for example by using a browser, and by accepting an offer of sale from the merchant 42, or by providing a purchase request to the merchant 42. In any case the customer 40 transmits a message of intent to the merchant 42, signifying his desire to complete the transaction. An example of such a message is the navigation to a checkout page by the customer 40. In some embodiments the message of intent includes an indication that the customer 40 is amenable to the use of intrinsic authorization. Such an indication may be embedded in the message by the secure private agent 44 as a part of its routine activity. Alternatively the customer 40 could receive a notification from the merchant 42 that it is amenable to the use of intrinsic authorization, and the message of intent would then confirm the participation of the customer 40 in intrinsic authorization.

In response to the message from the customer 40 that was sent in initial step 54, in step 56 the merchant 42 activates the intrinsic authorization mechanism. In other embodiments, the merchant 42 may choose to activate the intrinsic authorization mechanism at all times. The merchant 42 communicates with the merchant transaction tracking service 50, and requests issuance of a merchant transaction identifier (MTID), which is a unique identifier for the transaction. The merchant transaction tracking service 50 provides the merchant transaction identifier to the merchant 42, and establishes a record of the pending transaction.

In some embodiments the merchant 42 selects the merchant transaction identifier from a previously issued set of merchant transaction identifiers, or generates the merchant transaction identifier using some generation rule. The merchant 42 then communicates the merchant transaction identifier to the merchant transaction tracking service 50. The merchant transaction tracking service 50 confirms receipt of the merchant transaction identifier to the merchant 42.

Optionally the communication from the merchant 42 to the merchant transaction tracking service 50 in step 56 includes other conventional transaction details, which aid in the clearing of the transaction, for example quantity, price, and similar contract terms. Upon completion of step 56, the merchant transaction tracking service 50 is fully aware of the transaction in progress and its merchant transaction identifier, and the merchant 42 is aware that the transaction has been registered with the merchant transaction tracking service 50.

In step 58 the merchant 42 transmits its payment form to the customer 40. The payment form is conventional, except for an additional intrinsic authorization field, which contains the uniform resource locator (URL) of the merchant transaction tracking service 50 and the merchant transaction identifier which has been assigned to the transaction. This field may be hidden from the human user at the customer 40, and is preferably dealt with by the secure private agent 44.

At decision step 60 it is determined at the customer 40 if a configuration option for merchant verification has been enabled. This option is intended to provide the customer 40 with additional assurance that the merchant 42 is a valid client of the merchant transaction tracking service 50. The customer 40 will have been provided with a list of valid URLs of merchant transaction tracking services, and can compare the information in the intrinsic authorization field of the merchant's payment form against its own list.

If the merchant verification option is determined to be enabled in decision step 60, then at step 62 the customer 40 queries the merchant transaction tracking service 50 requesting verification of the merchant 42. The query in step 62 optionally includes a request for confirmation of certain transaction details, for example the total amount to be paid, as well as other details which may be of interest to the customer 40. If a satisfactory reply is received at decision step 64 from the merchant transaction tracking service 50, then execution continues at step 66. Otherwise, the transaction is aborted at final step 68.

If the merchant verification option is determined to be disabled in decision step 60, then execution proceeds to step 66, where the human user at the customer 40 “signs” an agreement binding him to the terms specified through the interaction with the merchant 42 at initial step 54, contingent upon authorization by the issuer 46. The signature may include a password. Preferably the signature of the customer 40 is authenticated by the secure private agent 44 according to the method disclosed in copending application Ser. No. 09/799,264, entitled “Authentication Technique for Electronic Transactions”, and filed Mar. 5, 2001, of common assignee herewith, and hereby incorporated by reference.

Control now passes to step 70. The issuer 46 receives a communication from the customer 40, which includes the signed version of the transaction agreement, and a flag, indicating that the transaction is subject to intrinsic authorization. The communication of step 70 also includes the contents of the intrinsic authorization field of the communication that was received in step 58. Preferably, the communication of step 70 also includes a virtual credit card number, which was assigned to the customer 40 by the secure private agent 44. The virtual credit card number is an aspect of the invention disclosed in the above noted application Ser. No. 09/737,148, and is employed in lieu of an actual credit card number to assure anonymity of the customer 40. On receipt of the communication, the issuer 46 authenticates the customer 40.

Next, at decision step 72, it is determined by the issuer 46 if a configuration option for verification of the merchant transaction tracking service 50 has been enabled. This option provides an independent opportunity to verify the authenticity of the transaction with the merchant transaction tracking service 50. If the determination at decision step 72 is affirmative, then at step 74 a communication is sent by the issuer 46 to the merchant transaction tracking service 50, requesting validation of the transaction. If, at decision step 76, a satisfactory reply is received, control passes to step 78. Otherwise, the transaction is aborted at final step 80.

If the verification option is determined to be disabled in decision step 72, then execution proceeds to step 78. Here, the issuer 46 may confirm the credit account of the customer 40, and depending upon the type of intrinsic authorization being requested, may perform other tasks related to the transaction. If the customer 40 is creditworthy, then the issuer 46 signs a digital certificate, which includes the merchant transaction identifier, the transaction amount, and preferably the virtual credit card number. In some embodiments, the actual credit card number may be used instead of the virtual credit card number. The digital signature is preferably accomplished by encryption, using the private key of the issuer 46. The well-known RSA cryptographic algorithm is suitable to encrypt the digital signature.

Next, at step 82 the issuer 46 transmits the signed digital certificate or message to the customer 40. Then, at step 84, the customer 40, upon receiving the signed digital message, returns the transaction documents, including the signed digital message to the merchant 42, and also sends the signed digital message, together with all other intrinsic authorization information, to the merchant transaction tracking service 50.

In some embodiments the issuer 46 may communicate the signed digital certificate directly to the merchant transaction tracking service 50 in step 84, avoiding the need to relay this information via the customer 40. However, in this variant, a copy of the signed digital certificate is still furnished to the customer 40 by the issuer 46 for his own record, and for relay to the merchant 42.

In decision step 86, upon receipt of the signed digital certificate, the merchant transaction tracking service 50 determines whether the digital certificate and other transaction details are valid. The presumptive identity of the issuer 46 is determinable in many ways, including the sequence number of the credit card account of the customer 40, whether a virtual credit card number or an actual credit card number. The identity of the issuer 46 may also be explicitly communicated in the intrinsic authorization data. In order to be assured that the digital certificate was signed by a valid issuer, the merchant transaction tracking service 50 consults a list of public keys and decrypts the signed digital certificate. The merchant transaction tracking service 50 also compares the merchant transaction identifier and other transaction details against the record, which was created in step 56.

If the intrinsic authorization of the transaction is determined to be invalid at decision step 86, the transaction is flagged at step 88 by the merchant transaction tracking service 50. Otherwise, the transaction is flagged as valid at step 90. In either case execution continues at step 92.

At step 92 the merchant 42 has received the communication sent in step 84. It now sends a transaction verification request to the merchant transaction tracking service 50. This is normally in the form of an authorization request to an acquirer, but in this case the merchant 42 is aware that intrinsic authorization is expected, and the request is therefore directed to the merchant transaction tracking service 50 instead of the acquirer 48. The transaction verification request includes the merchant transaction identifier for the transaction. The merchant transaction tracking service 50 accesses its record, using the merchant transaction identifier, and responds in accordance with the flag that was set in step 88 or step 90. Then at decision step 94 a test is made by the merchant 42 to determine if the transaction has been verified. If not, then the transaction is aborted at step 96. Otherwise control proceeds to decision step 98. Here a determination is made by the merchant 42 whether the transaction is of a nature that requires supplemental authorization from the issuer 46. Supplemental authorization is an optional procedure, and is subject to the particular control policies of the merchant 42 or the issuer 46.

If no supplemental authorization is determined to be required at decision step 98, then the transaction is completed at final step 100. Otherwise, at step 102 a conventional request is sent to the issuer 46, requesting supplemental authorization for the transaction, and a reply received.

Next, at decision step 104 it is determined at the merchant 42 whether supplemental authorization was granted by the issuer 46. If not, the transaction is aborted at step 106. Otherwise, the transaction is completed at final step 100. The terms of the transaction are recognized as an obligation of the merchant 42, which then institutes routine settlement procedures via the acquirer 48.

First Alternate Embodiment

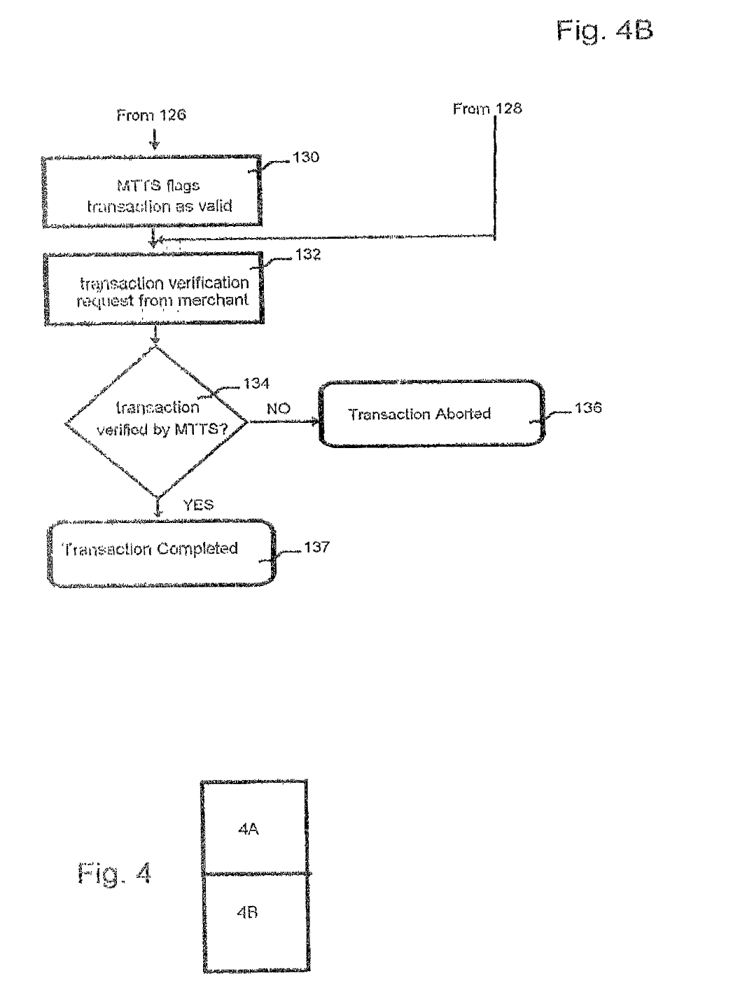

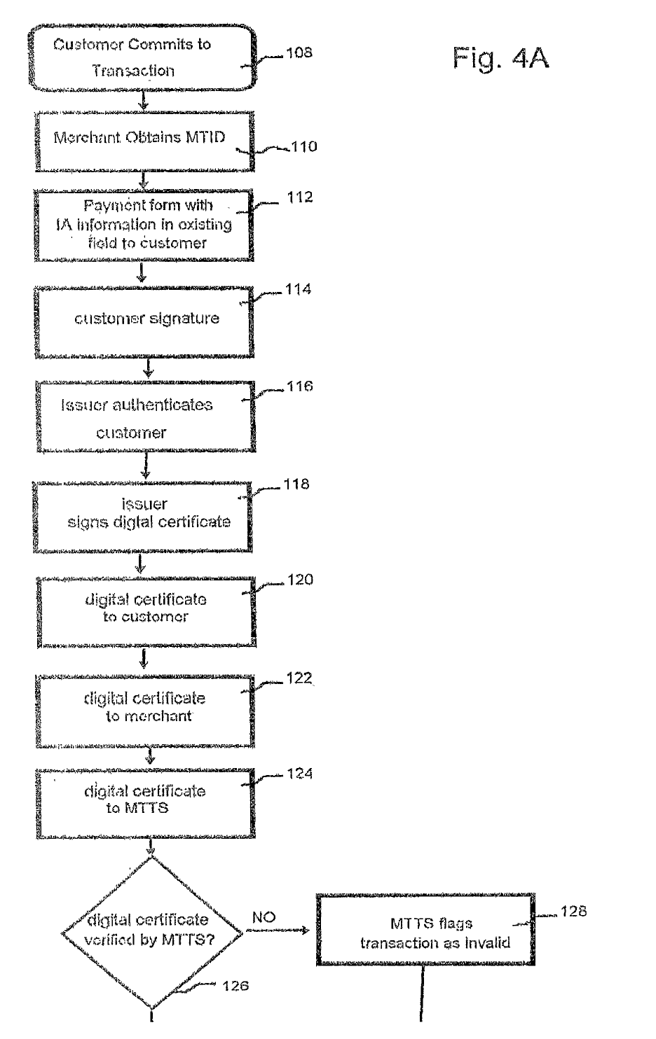

Reference is now made to FIG. 4, which is a flow chart illustrating a process of intrinsic authorization of an electronic transaction in accordance with a first alternate embodiment of the invention. The description of FIG. 4 is to be read in conjunction with FIG. 2. The participants in the process, and their relationships are the same as in the first embodiment.

At initial step 108, the customer 40 accesses the electronic commerce site of the merchant 42. Initial step 108 is identical to initial step 54 (FIG. 3) of the first embodiment. In response to the message from the customer 40 that was sent in initial step 108, the merchant 42 activates the intrinsic authorization mechanism in step 110. Step 110 is identical to step 56 (FIG. 3) of the first embodiment, and, as explained above, upon completion of step 110, a unique merchant transaction identifier has been assigned to the transaction. It is possible for the merchant transaction identifier to be a conventional unique identifier, such as an order number, if the merchant 42 already provides such in his normal operations.

In step 112, the merchant 42 transmits its payment form to the customer 40. The payment form is conventional, except for intrinsic authorization information, which occupies existing fields. For example, the intrinsic authorization information could be placed in one of the address lines, or as an addendum to the name of the user. The intrinsic authorization information includes the merchant transaction identifier, and optionally includes an identifier of the merchant transaction tracking service 50. In the communication of step 112, the URL of the merchant transaction tracking service 50 is omitted. It will be appreciated from the disclosure which follows, that there is no need for the customer 40, the secure private agent 44, or the issuer 46 to ever communicate directly with the merchant transaction tracking service 50.

Execution now proceeds to step 114, where the human user at the customer 40 “signs” the payment form, binding him to the terms specified in the transaction. Step 114 is identical to step 66(FIG. 3) of the first embodiment. In this embodiment, the customer 40 is not afforded the opportunity of validating the merchant via the facilities of the merchant transaction tracking service 50.

Control now passes to step 116. The issuer 46 receives a communication from the customer 40, which includes the signed version of the transaction agreement, and a flag, indicating that the transaction is subject to intrinsic authorization. The communication of step 116 also includes the intrinsic authorization information, which was supplied by the merchant 42 in the payment form that was transmitted to the customer 40 in step 112.

Next, at step 118, the issuer 46 evaluates the communication that was received in step 116. Step 118 is identical to step 78 (FIG. 3) of the first embodiment. It will be noted that in this embodiment, the issuer 46 is not afforded the opportunity to validate the merchant transaction tracking service 50, as in the first embodiment.

Control proceeds to step 120, the issuer 46 transmits the signed digital certificate to the customer 40. Unlike some variations of the first embodiment, in this alternate embodiment the issuer 46 never communicates the digital signature to the merchant transaction tracking service 50.

Upon receipt of the signed digital certificate, at step 122 the customer 40 relays the signed digital certificate and the intrinsic authorization information to the merchant 42. The customer 40 does not send the signed digital certificate and intrinsic authorization information directly to the merchant transaction tracking service 50. Instead, at step 124, the merchant transaction tracking service 50, preferably operating in batch mode, retrieves the signed digital certificate and associated intrinsic authorization information from the files of the merchant 42. In some embodiments of step 124, the merchant 42 may expedite the intrinsic authorization of the transaction by expressly sending the signed digital certificate to the merchant transaction tracking service 50, optionally in conjunction with a transaction verification request.

Control proceeds to decision step 126, where the merchant transaction tracking service 50 determines whether the digital certificate and other transaction details are valid. This is accomplished in the same way as decision step 86 (FIG. 3) of the first embodiment.

If the intrinsic authorization of the transaction is determined to be invalid at decision step 126, the transaction is flagged at step 128 by the merchant transaction tracking service 50. Otherwise, the transaction is flagged as valid at step 130. In either case execution continues at step 132, wherein a communication is sent by the merchant transaction tracking service 50 to the merchant 42. In some embodiments this communication is responsive to an explicit transaction verification request from the merchant 42, while in other embodiments the communication is initiated by the merchant transaction tracking service 50. The communication is in accordance with the flag that was set in step 128 or step 130. Then at decision step 134 a test is made by the merchant 42 to determine if the transaction has been verified. If not, then the transaction is aborted at step 136. Otherwise control proceeds to final step 137, where the transactions is successfully completed, subject, as in the case of the first embodiment, to possible supplemental authorization by the issuer 46. The process of obtaining supplemental authorization is identical to the first embodiment, and is not repeated in the interest of brevity.

This alternate embodiment has the advantage of simplicity in the authorization process. However there is a tradeoff, in that opportunity for mutual validation of the parties to the transaction is limited by the absence of the field identifying the URL of the merchant transaction tracking service 50. However, this embodiment is interoperable with present arrangements with minimal modifications to the existing systems.

Second Alternate Embodiment

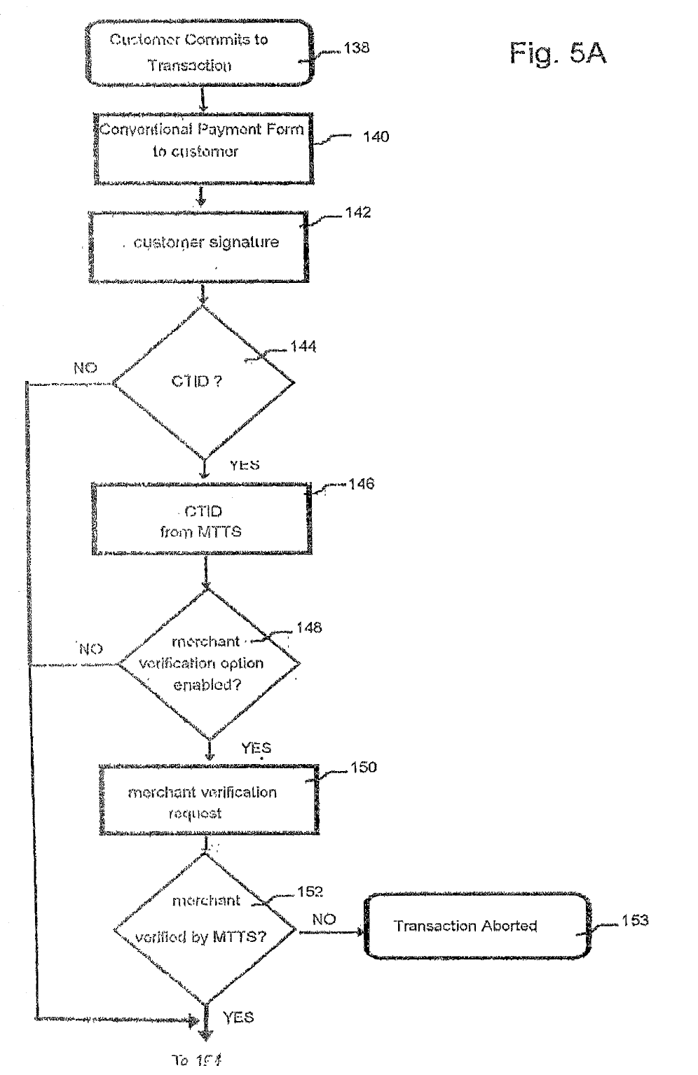

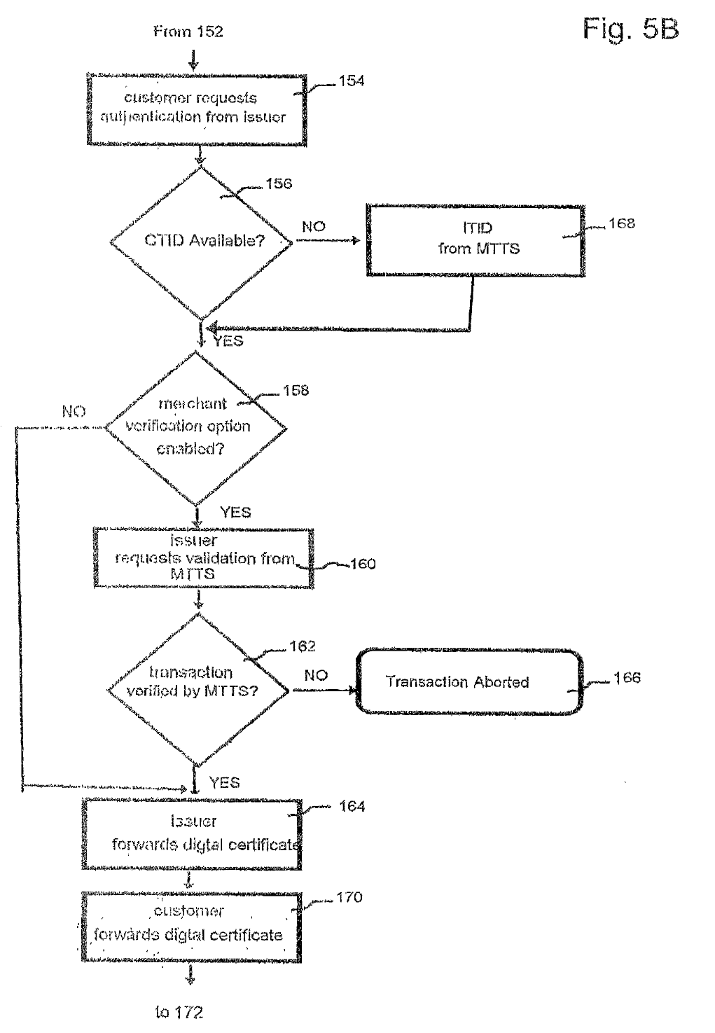

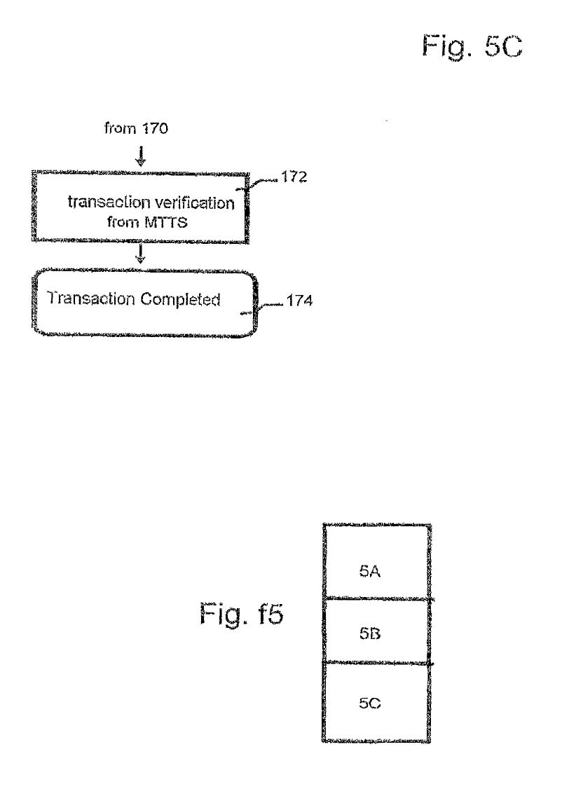

Reference is now made to FIG. 5, which is a flow chart illustrating a process of intrinsic authorization of an electronic transaction in accordance with an second alternate embodiment of the invention. The description of FIG. 5 is to be read in conjunction with FIG. 2. The participants in the process, and their relationships are the same as in the first embodiment. The second alternate embodiment enables intrinsic authorization to occur in an electronic transaction, despite the fact that the merchant may not have established a relationship with a merchant transaction tracking service, and may not have adjusted its payment form to comply with the enhancements provided by the intrinsic authorization process. Nevertheless, when at least one of the customer and the issuer have adopted intrinsic authorization as a preferred method of performing electronic transactions, it is still possible to authorize a transaction according to the teachings of the invention using this alternate embodiment.

At initial step 138 the customer 40 accesses the electronic commerce site of the merchant 42 and commits to an electronic transaction. Initial step 138 is identical to initial step 54 (FIG. 3) of the first embodiment. In response to the message from the customer 40 that was sent in initial step 138, in step 140 the merchant 42 responds with by sending a conventional payment form to the customer 40. The merchant 42 does not activate the intrinsic authorization mechanism.

Execution now proceeds to step 142, where the human user at the customer 40 “signs” the payment form, binding him to the terms specified in the transaction. Step 142 is similar to step 66 (FIG. 3) of the first embodiment, except now, if the customer 40 is aware of the advantages of the intrinsic authorization, it will have recognized that the merchant 42 did not provide a merchant transaction identifier in its payment form. At decision step 144, it is determined by the customer 40 whether to actively participate in the intrinsic authorization of the transaction. The decision may be based on a preexisting control policy, which considers, for example, the size of the transaction, previous custom of dealing with the merchant 42, and the relationship between the customer 40 and the issuer 46. If it is determined to participate actively, then at step 146 the customer 40 contacts the merchant transaction tracking service 50 and secures a customer transaction identifier (CTID), which has a similar function in the process of intrinsic authorization as the merchant transaction identifier disclosed above. Alternatively the customer 40 may allocate or generate the customer transaction identifier in the same manner as was done by the merchant 42 in step 56 of the first embodiment (FIG. 3).

The customer 40 has the opportunity to request the merchant transaction tracking service 50 to validate the merchant 42. At decision step 148, it is determined at the customer 40 if a configuration option for merchant verification has been enabled. This option is intended to provide the customer 40 with additional assurance that the merchant 42 is a either a valid client of the merchant transaction tracking service 50, or is at least known to the merchant transaction tracking service 50. If the merchant verification option is determined to be enabled in decision step 148, then at step 150 the customer 40 queries the merchant transaction tracking service 50, requesting verification of the merchant 42. If a satisfactory reply is received at decision step 152 from the merchant transaction tracking service 50, then execution continues at step 154. Otherwise, the transaction is aborted at final step 153.

If the merchant verification option is determined to be disabled in decision step 148, or if the customer is not an active participant in the intrinsic authorization process as determined in decision step 144, then execution proceeds to step 154.

Next, in step 154, the customer 40 communicates with the issuer 46 requesting authorization for the transaction. The communication includes the signed version of the transaction agreement. If a customer transaction identifier was assigned to the transaction in step 142, the customer 40 includes it in communications with the issuer 46. Preferably, an identification of the merchant transaction tracking service 50, such as its URL, is also included in the communications, in order to assist the issuer 46 in verifying the transaction. The communication of step 154 preferably includes a virtual credit card number, which was assigned to the customer 40 by the secure private agent 44. A flag is set in step 154 if the customer 40 has obtained a customer transaction identifier, thus indicating that the transaction is subject to intrinsic authorization, even though no merchant transaction identifier has been issued. If the customer 40 has not obtained a customer transaction identifier, then the flag is cleared, indicating that the transaction is not previously subject to intrinsic authorization.

The issuer 46 then determines at decision step 156 whether the customer 40 has provided a customer transaction identifier. This is done by evaluating the condition of the flag that was set in step 154. The issuer 46 will be also be aware from the communication of step 154 that no merchant transaction identifier exists for the transaction. If at decision step 156 a transaction identifier has been provided, control proceeds to decision step 158 where it is determined if a configuration option for verification of the merchant transaction tracking service 50 has been enabled. This option provides an independent opportunity to verify the authenticity of the transaction with the merchant transaction tracking service 50. If the determination at decision step 158 is affirmative, then at step 160 a communication is sent by the issuer 46 to the merchant transaction tracking service 50 requesting validation of the transaction. If, at decision step 162, a satisfactory reply is received, control passes to step 164. Otherwise, the transaction is aborted at final step 166. If the verification option is determined to be disabled in decision step 158, then execution proceeds to step 164.

If it is determined at decision step 156 that the customer 40 has not provided a customer transaction identifier, then at step 168 the issuer 46 contacts the merchant transaction tracking service 50 and secures a issuer transaction identifier (ITID), which has a similar function in the technique of intrinsic authorization as the merchant transaction identifier disclosed above. Alternatively, the issuer 46 may allocate or generate the issuer transaction identifier in the same manner as was done by the merchant 42 in step 56 of the first embodiment (FIG. 3). Control then passes to decision step 158.

At step 164, the issuer 46 may confirm the credit account of the customer 40. If the customer 40 is creditworthy, then the issuer 46 signs a digital certificate, which includes the customer transaction identifier or the issuer transaction identifier, whichever is applicable, the transaction amount, and preferably the virtual credit card number. In some embodiments, the actual credit card number may be used instead of the virtual credit card number. The digital signature can be accomplished in the same manner as in step 78 (FIG. 3) of the first embodiment. If an issuer transaction identifier has been assigned, then the issuer 46 transmits the signed digital certificate to the merchant transaction tracking service 50 and the customer 40. If a customer transaction identifier has been assigned, the issuer 46 transmits the signed digital certificate to the customer 40.

Next, at step 170, the customer 40, having received the signed digital certificate, sends the completed payment form to the merchant 42. If a customer transaction identifier has been assigned, the customer 40 also forwards the signed digital certificate to the merchant transaction tracking service 50. The merchant 42 is advised that the transaction is subject to intrinsic authorization. It is optional for a copy of the signed digital certificate to accompany the completed payment form in the communication between the customer 40 and the merchant 42. However, it is preferable that the customer 40 informs the merchant 42 in any case that the transaction has been processed in accordance with intrinsic authorization.

Control then proceeds to step 172, wherein a communication is sent by the merchant transaction tracking service 50 to the merchant 42. In some embodiments this communication is responsive to an explicit transaction verification request from the merchant 42, while in other embodiments the communication is initiated by the merchant transaction tracking service 50. The communication advises the merchant 42 that the intrinsic authorization has been issued. Control proceeds to final step 174, where the transaction is successfully completed, subject, as in the first embodiment, to possible supplemental authorization by the issuer 46. The process of obtaining supplemental authorization is identical to the first embodiment, and is not repeated in the interest of brevity.

While this invention has been explained with reference to the structure disclosed herein, it is not confined to the details set forth, and this application is intended to cover any modifications and changes as may come within the scope of the following claims:

What is claimed is:

1. A computer implemented method of authorizing an electronic transaction, comprising the steps of:
receiving a notification of a pending electronic transaction from a first participant therein, wherein another participant therein is an authority responsible for authorizing said pending electronic transaction;
responsive to said notification, associating a transaction identifier with said pending electronic transaction;
communicating said transaction identifier to said first participant, wherein said first participant relays said transaction identifier to at least one other participant in said pending electronic transaction;
thereafter receiving said transaction identifier and a digital certificate that authorizes said pending electronic transaction, said digital certificate being signed by said authority;
verifying said digital certificate; and
providing an indication of said digital certificate.

2. The method according to claim 1, wherein further comprising the step of authenticating said first participant to a second participant in said electronic transaction upon a request therefrom that is associated with said transaction identifier.

3. The method according to claim 2, wherein said second participant is said authority.

4. The method according to claim 1, wherein said step of providing said indication of said digital certificate is performed by providing said indication to said first participant.

5. The method according to claim 4, wherein said step of providing said indication of said digital certificate is performed responsive to a transaction verification request of said first participant.

6. The method according to claim 4, wherein said step of providing said indication of said digital certificate is performed automatically.

7. The method according to claim 1, wherein said step of associating said transaction identifier is performed by generating said transaction identifier.

8. The method according to claim 1, wherein said step of associating said transaction identifier is performed by
providing said first participant with a range of transaction identifiers, wherein said first participant allocates said transaction identifier from said range; and
receiving said transaction identifier from said first participant.

9. The method according to claim 1, wherein said step of associating said transaction identifier is performed by
providing said first participant with a rule for generating transaction identifiers, wherein said first participant generates said transaction identifier in accordance with said rule; and
receiving said transaction identifier from said first participant.

10. The method according to claim 1, wherein said steps of receiving said notification, communicating said transaction identifier, receiving said transaction identifier and said digital certificate, and providing said indication are performing using a data network.

11. The method according to claim 10, wherein said data network is an internet.

12. The method according to claim 1, wherein said digital certificate is encrypted by a private key of said authority.

13. A computer implemented method of authorizing an on-line credit card transaction between a customer and a merchant, comprising the steps of:
receiving a notification of said on-line credit card transaction from said merchant via a data network;
associating a transaction identifier with said on-line credit card transaction;
communicating said transaction identifier to said merchant via said data network, wherein responsive to receiving said transaction identifier, said merchant includes said transaction identifier in a payment form that is submitted to said customer, and said customer relays said transaction identifier to an authority responsible for authorizing said on-line credit card transaction and returns said payment form to said merchant, an identifier of a credit card account of said customer being communicated with said payment form;
receiving via said data network said transaction identifier and a digital certificate that includes said identifier of said credit card account and authorizes said on-line credit card transaction, said digital certificate being signed by said authority;
verifying said digital certificate; and
providing an indication of said digital certificate to said merchant via said data network.

14. The method according to claim 13, further comprising the steps of:
following said step of communicating said transaction identifier to said merchant, receiving via said data network said transaction identifier and a request from said customer to authenticate said merchant, said request including said transaction identifier; and
responsive to said request, verifying an identity of said merchant to said customer via said data network.

15. The method according to claim 13, further comprising the steps of:
following said step of communicating said transaction identifier to said merchant, receiving via said data network said transaction identifier and a request from said authority to authenticate said on-line credit card transaction, said request including said transaction identifier; and
responsive to said request, communicating an authentication of said on-line credit card transaction to said authority via said data network.

16. The method according to claim 13, wherein said digital certificate is received from said authority.

17. The method according to claim 13, wherein said digital certificate is received from said customer.

18. The method according to claim 13, wherein said digital certificate is received from said merchant.

19. The method according to claim 13, wherein said step of providing said indication of said digital certificate is performed responsive to a transaction verification request from said merchant.

20. The method according to claim 13, wherein said step of providing said indication of said digital certificate is performed automatically.

21. The method according to claim 13, wherein said step of associating said transaction identifier is performed by generating said transaction identifier.

22. The method according to claim 13, wherein said step of associating said transaction identifier is performed by
providing said merchant with a range of transaction identifiers, wherein said merchant allocates said transaction identifier from said range; and
receiving said transaction identifier from said merchant.

23. The method according to claim 13, wherein said step of associating said transaction identifier is performed by
providing said merchant with a rule for generating transaction identifiers, wherein said merchant generates said transaction identifier in accordance with said rule; and
receiving said transaction identifier from said merchant.

24. The method according to claim 13, wherein said transaction identifier is embedded in a hidden field of said payment form.

25. The method according to claim 13, wherein said transaction identifier is embedded in a visible field of said payment form.

26. The method according to claim 13, wherein said digital certificate is encrypted by a private key of said authority.

27. A computer implemented method of authorizing an on-line credit card transaction between a customer and a merchant, comprising the steps of:
receiving a notification of said on-line credit card transaction from said customer via a data network;
associating a transaction identifier with said on-line credit card transaction;
communicating said transaction identifier to said customer via said data network, wherein responsive to receiving said transaction identifier, said customer includes said transaction identifier in a communication that is submitted to an authority responsible for authorizing said on-line credit card transaction and returns a payment form to said merchant, an identifier of a credit card account of said customer being communicated with said payment form;
receiving via said data network said transaction identifier and a digital certificate that includes said identifier of said credit card account and authorizes said on-line credit card transaction, said digital certificate being signed by said authority;
verifying said digital certificate; and
providing an indication of said digital certificate to said merchant via said data network.

28. The method according to claim 27, further comprising the steps of:
following said step of communicating said transaction identifier to said customer, receiving via said data network said transaction identifier and a request from said authority to authenticate said on-line credit card transaction, said request including said transaction identifier; and
responsive to said request, providing an authentication of said on-line credit card transaction to said authority via said data network.

29. The method according to claim 27, wherein said digital certificate is received from said authority.

30. The method according to claim 27, wherein said digital certificate is received from said customer.

31. The method according to claim 27, wherein said digital certificate is received from said merchant.

32. The method according to claim 27, wherein said step of providing said indication of said digital certificate is performed responsive to a transaction verification request from said merchant.

33. The method according to claim 27, wherein said step of providing said indication of said digital certificate is performed automatically.

34. The method according to claim 27, wherein said step of associating said transaction identifier is performed by generating said transaction identifier.

35. The method according to claim 27, wherein said step of associating said transaction identifier is performed by
providing said customer with a range of transaction identifiers, wherein said customer allocates said transaction identifier from said range; and
receiving said transaction identifier from said customer.

36. The method according to claim 27, wherein said step of associating said transaction identifier is performed by
providing said customer with a rule for generating transaction identifiers, wherein said customer generates said transaction identifier in accordance with said rule; and
receiving said transaction identifier from said customer.

37. The method according to claim 27, wherein said digital certificate is encrypted by a private key of said authority.

38. A computer implemented method of authorizing an on-line credit card transaction between a customer and a merchant, comprising the steps of:
receiving a notification of said on-line credit card transaction from an authority responsible for authorizing said on-line credit card transaction via a data network;
associating a transaction identifier with said on-line credit card transaction;
communicating said transaction identifier to said authority via said data network,
receiving via said data network said transaction identifier and a digital certificate that authorizes said on-line credit card transaction, said digital certificate being signed by said authority;
verifying said digital certificate; and
providing an indication of said digital certificate to said merchant via said data network.

39. The method according to claim 38, further comprising the steps of:
authenticating said on-line credit card transaction; and
providing an authentication of said on-line credit card transaction to one of said customer and said authority via said data network.

40. The method according to claim 38, wherein said digital certificate is received from said authority.

41. The method according to claim 38, wherein said digital certificate is received from said customer.

42. The method according to claim 38, wherein said digital certificate is received from said merchant.

43. The method according to claim 38, wherein said step of providing said indication of said digital certificate is performed responsive to a transaction verification request from said merchant.

44. The method according to claim 38, wherein said step of providing said indication of said digital certificate is performed automatically.

45. The method according to claim 38, wherein said step of associating said transaction identifier is performed by generating said transaction identifier.

46. The method according to claim 38, wherein said step of associating said transaction identifier is performed by
providing said authority with a range of transaction identifiers, wherein said authority allocates said transaction identifier from said range; and
receiving said transaction identifier from said authority.

47. The method according to claim 38, wherein said step of associating said transaction identifier is performed by
providing said authority with a rule for generating transaction identifiers, wherein said authority generates said transaction identifier in accordance with said rule; and
receiving said transaction identifier from said authority.

48. The method according to claim 38, wherein said digital certificate is encrypted by a private key of said authority.
